(19) United States
(12) Patent Application Publication
(10) Pub. No.: US 2018/0140984 A1
(43) Pub. Date: May 24, 2018

(54) DISK SEPARATOR WITH WELDED PLASTIC HOUSING

(71) Applicant: POLYTEC PLASTICS GERMANY GMBH & CO. KG, Lohne (DE)

(72) Inventors: Hans JANSSEN, Dinklage (DE); Sebastian PYTEL, Lohne (DE); Christoph SPREHE, Osnabrück (DE)

(73) Assignee: POLYTEC PLASTICS GERMANY GMBH & CO. KG, Lohne (DE)

(21) Appl. No.: 15/574,306

(22) PCT Filed: May 20, 2016
(86) PCT No.: PCT/EP2016/061391

§ 371 Date: Nov. 15, 2017

(30) Foreign Application Priority Data
May 29, 2015 (DE) 10 2015 209 908.3

(51) Int. Cl. B01D 45/14; B04B 1/04

(52) U.S. Cl. CPC B01D 45/14; B04B 2005/125; B04B 1/04

(57) ABSTRACT

The invention relates to a disk separator for cleaning gases, in particular blow-by gases of the crankcase ventilation of motor vehicles, comprising an upper housing part and a lower housing part, the upper housing part and the lower housing part comprising a plastic material.

### FIELD OF THE INVENTION

The invention relates to a disk separator for cleaning gases, in particular blow-by gases of the crankcase ventilation of motor vehicles, comprising an upper housing part and a lower housing part.

### BACKGROUND OF THE INVENTION

Disk separators for cleaning gases have long been known. Thus, the Swedish Patent SE 101843 described a disk separator for cleaning gases as early as in 1940. U.S. Pat. No. 2,417,747 describes a centrifuge for separating liquids from gases and severe contaminants. From DE 4311906 A1, an oil centrifuge is known that is employed for cleaning crankcase gases in engines of passenger cars. WO90/05028 describes the design of the disks of a disk separator.

Disk separators are in standard use as fine oil separators in trucks. In a disk separator, the blow-by gas with fine oil droplets flows through the rotor equipped with rotating disks with conical shapes. Such a rotor rotates at up to 10,000 rpm. Because of the centrifugal forces occurring therein, the oil droplets are thrown against the lower sides of the disk and separated off. The cleaned blow-by gas is guided off through a blow-by exit and recirculated to the engine suction. The separated oil is recirculated to the engine through an oil draining line.

The rotors of such a disk separator are usually driven through an electric motor or an oil turbine. These rotors are usually employed in processed aluminum housings closed by top and bottom covers. The aluminum housings are complicated to process. Housings, rotor fixtures and covers are usually mounted together with seals, and screwed together. The heavy aluminum housing is able to absorb the vibrations and thus damp the noise. When there is unbalance, this may lead to vibrations. Therefore, a rigid construction of the housing is important. Vibration damping by mass is undesirable when the part is to be mounted into a passenger car.

Since such oil separators with aluminum housings are too heavy for passenger car applications, they have not yet been employed for passenger cars. Therefore, passenger car applications need a lightweight separator, which dispenses with weights for balancing vibrations.

### BRIEF SUMMARY OF THE INVENTION

According to the invention, the above object is achieved by a disk separator for cleaning gases, in particular blow-by gases of the crankcase ventilation of motor vehicles, comprising an upper housing part 1 and a lower housing part 2, which is characterized in that each of said upper housing part 1 and lower housing part 2 comprises, especially consists of, a plastic material.

### BRIEF DESCRIPTION OF THE DRAWINGS

The present invention is illustrated and described herein with reference to the various drawings, in which like reference numbers denote like method steps and/or system components, respectively, and in which:

FIG. 1 illustrates the disk separator of the present invention with the upper housing part and the lower housing part welded to the flange;

FIG. 2 illustrates the disk separator of the present invention with the rotor support welded onto the lower housing part;

FIG. 3 illustrates the disk separator of the present invention with ball bearing pressed into the guiding sleeve;

FIG. 4 illustrates the disk separator of the present invention with a ball bearing pressed into the rotor support;

FIG. 5 illustrates the disk separator of the present invention with the steel sleeve inserted into the rotor support.

### DETAILED DESCRIPTION OF THE INVENTION

The weight of the disk separator according to the invention can be significantly reduced if a plastic material, especially a fiber-reinforced polyamide, more preferably one reinforced by glass fibers and/or carbon fibers, is used as the material for the upper housing part 1 and/or the lower housing part 2.

Since the plastic material has only about 50% of the density of aluminum, it is recommended that the housing upper shell and lower shell be prepared of plastic, preferably a glass-fiber reinforced polyamide, and thus save weight considerably. However, the modulus of elasticity of the plastic material, being about 10,000 N/mm², is clearly lower than that of aluminum, being 70,000 N/mm². Therefore, a structural reinforcement of the construction is reasonable in order to obtain a solid component that resists vibrational excitations.

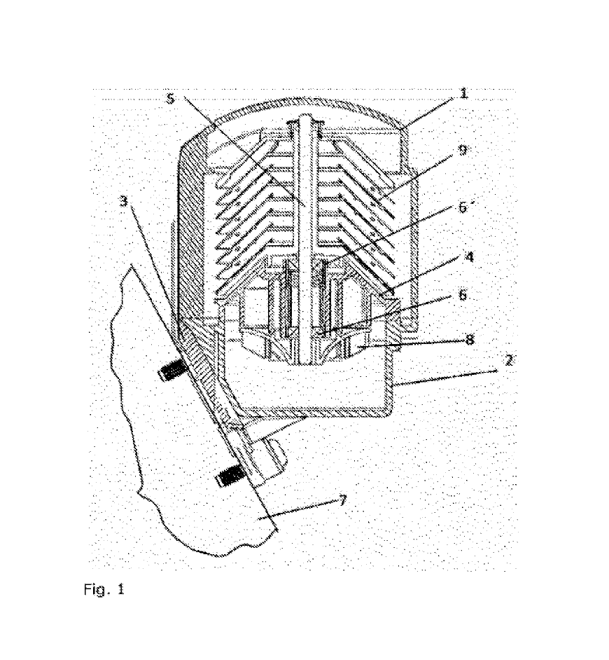

In contrast to aluminum, a plastic material can be welded relatively easily. Therefore, in order to increase the rigidity of the construction, it is recommended to weld the upper housing part 1 and the lower housing part 2 of the disk separator housing with the adjacent plastic components. Welding two shells 1, 2 together can form closed hollow spaces that achieve a significantly greater rigidity as compared to the injection-molded single shells. Thus, for example, the upper housing part 1 and/or the lower housing part 2 can be welded to the adjacent flange 3, as shown in FIG. 1.

FIG. 1 further shows the disk separator according to the invention with the essential properties. The upper housing part 1 is welded to the lower housing part 2. Within the housing, there is the rotor 5 in the rotor bearing 6, which is integrated into the rotor support 4. Here, the flange 3 is welded with the lower housing part [4] 2. Within the housing, the drive paddle wheel 8 and the disks 9 of the disk separator can be recognized. The disk separator is connected with engine block 7 through the flange 3.

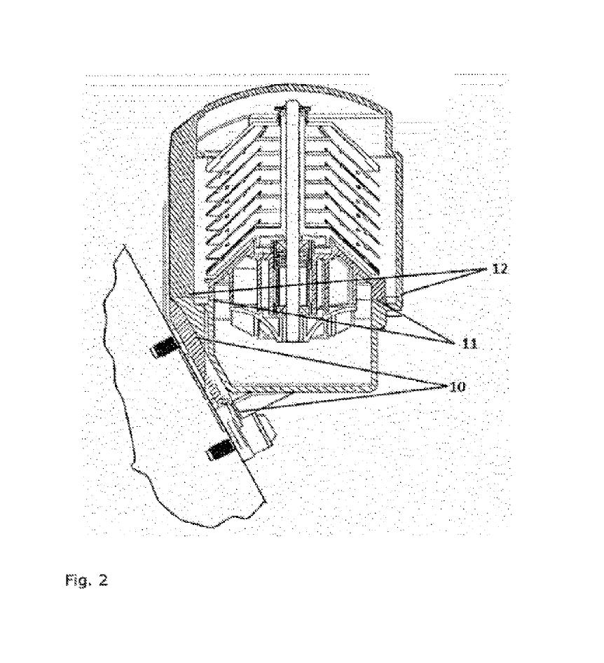

Another increase in rigidity is obtained by welding the rotor support 4 into the lower housing part 2 as shown in FIG. 2. In addition, this Figure shows the different welding levels. Reference symbol 10 shows the weld between the flange 3 and the lower housing part 2. The weld between the lower housing part 2 and the rotor support 4 has the reference symbol 11, while the weld between the upper housing part 1 and the lower housing part is provided with reference symbol 12.

If the upper housing part 1 is welded with the lower part 1, an integral housing with a closed supporting surface is obtained.

As compared to screwed upper and lower parts sealed by elastomer seals, which represent two open shells, welding yields a closed surface of the housing. This housing is able to dissipate forces on the whole surface. This results in a clearly higher structural rigidity of the housing as compared to screwed half shells.

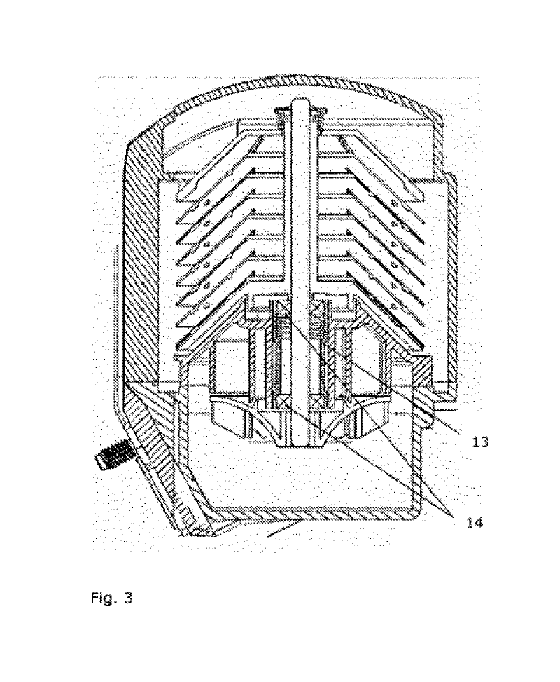

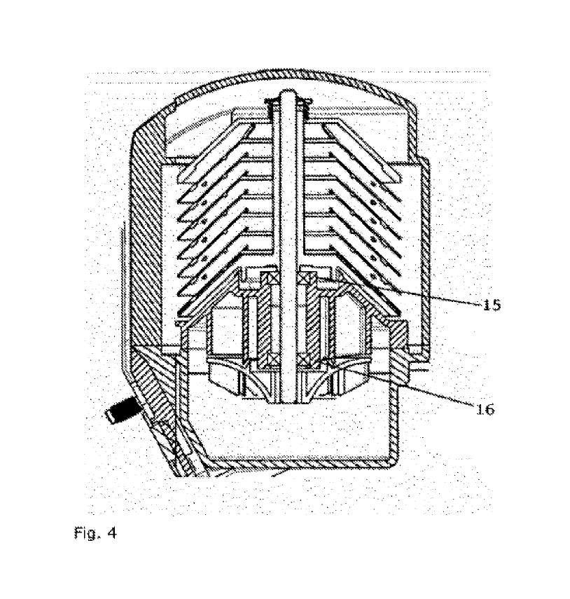

When a plastic material is used as the housing for rotors, the bearing is also to be designed in a particular way. Preferably, the rotor axis 5 is supported with ball bearings in the rotor support 4 made of plastic. It is possible to injection-mold a ball bearing directly into the rotor support 4, and to press in the second one, especially if the rotor support 4 is also made of the same plastic material. These embodiments are shown in FIGS. 3 and 4.

Another possibility is to injection-mold a metal sleeve 13 into the plastic rotor support 4, and to mount both rotor supports in this sleeve 13. This rotor mounting embodied as a cantilever beam has the advantage that the rotor 5 has no direct contact with the external housing, and thus vibrations from rotor 5 are not directly guided through.

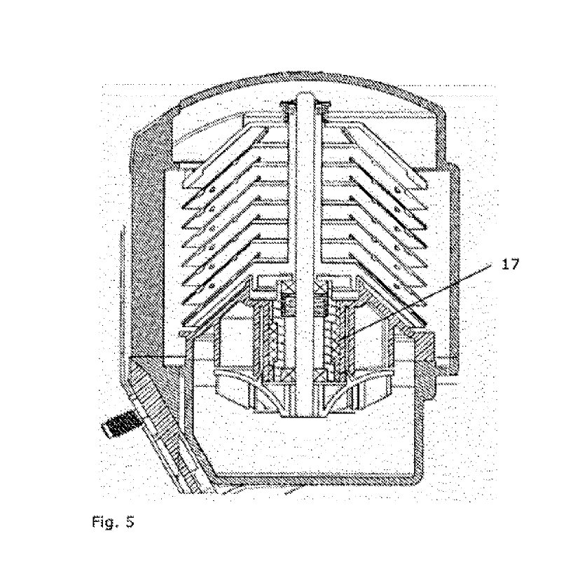

Another advantageous embodiment is to coat a steel sleeve 14, for example, with an elastomer, for receiving the bearing, and to insert it into the rotor support 4 to thereby decouple the rotor mounting to the housing. This embodiment is shown in FIG. 5.

Another advantage of welding the housing together is the fact that no elastomer seals are needed between the housing parts to seal the oil-containing disk separator towards the environment. The same applies to interior seals of the rotor support 4 towards the housing. Here too, oil-containing volumes have to be separated closely from one another. The welding is oil-tight, and a seal is no longer required.

The necessary ports and supply lines for blow-by gas supply and blow-by gas recirculation can be shaped in the plastic lower part 2 through the on-welded flange 3. The same applies to the oil drive of rotor 5. If the rotor 5 is driven through the oil pressure of the oil pump, an oil jet is directed through a small nozzle onto a drive paddle 7. The latter is rotated thereby. A pressurized oil supply and an oil return line are required for this. Further, a channel for the separated oil can be integrated by molding. Such channels can be produced by welding together different housing parts, for example, from two half shells.

If the disk separator is made of plastic, no processing of the sealing surfaces is necessary. All oil- and gas-conducting lines can be guided through to the flange 3. By screwing the flange 3 through a seal to the engine block, all connecting lines are thus connected.

The component according to the invention as a closed structural body can be screwed directly with the engine and can thus use the mass of the engine block as a solid bearing. The vibrational amplitudes and deformations are highly reduced by the rigidity of the welded housing structure. Ideally, an integral housing having the rotor bearing 6 in its interior is obtained by the welding.

Because of the welded design of the plastic housing, a lightweight disk separator having a weight of less than 500 g can be prepared. It can be flange-mounted directly to the engine. The channels for oil and gas transport prepared by welding can be integrated. The disk separator is firmly screwed onto the heavy engine block by the rigid welded housing, wherein the rotating rotor 5 is supported in the interior of the housing.

### LIST OF REFERENCE SYMBOLS

1. upper housing part
2. lower housing part
3. flange
4. rotor support
5. rotor
6. rotor bearing
7. engine block
8. drive paddle wheel
9. disk
10. flange/lower housing part weld
11. lower housing part/rotor support weld
12. lower housing part/upper housing part weld
13. metal guiding sleeve
14. ball bearing pressed into guiding sleeve
15. ball bearing pressed into rotor support
16. ball bearing injection-molded into rotor support
17. bearing sleeve supported in elastomer

1. A disk separator for cleaning gases, in particular blow-by gases of the crankcase ventilation of motor vehicles, comprising an upper housing part and a lower housing part,
characterized in that
each of said upper housing part and lower housing part comprises a plastic material.

2. The disk separator according to claim 1, characterized in that said plastic material is fiber-reinforced, especially reinforced by glass fibers and/or carbon fibers.

3. The disk separator according to claim 1, characterized in that said plastic material includes polyamide.

4. The disk separator according to any of claim 1, characterized in that said upper housing part is welded to said lower housing part.

5. The disk separator according to any of claim 1, characterized in that said upper housing part and/or said lower housing part is provided with a mounting flange for mounting on the engine side.

6. The disk separator according to claim 5, characterized in that said flange comprises a plastic material.

7. The disk separator according to claim 5, characterized in that said flange is welded to said upper housing part and/or said lower housing part.

8. The disk separator according to any of claim 1, characterized in that the rotor support of the rotor is supported on a ball bearing.

9. The disk separator according to claim 8, characterized in that said rotor support comprises a plastic material.

10. The disk separator according to claim 8, characterized in that a ball bearing is injection-molded into said rotor support.

11. The disk separator according to any of claim 8, characterized in that a second ball bearing is injection-molded into said rotor support.

12. The disk separator according to any of claim 8, characterized in that a metal sleeve is injection-molded into said rotor support.

13. The disk separator according to claim 12, characterized in that said metal sleeve is made of steel, and the bearing seat is coated with an elastomer.

14. The disk separator according to any of claim 1, characterized in that said rotor support is welded to said upper housing part and/or said lower housing part.
